(19) United States
(12) Patent Application Publication
(10) Pub. No.: US 2004/0240673 A1
(43) Pub. Date: Dec. 2, 2004

(54) Device for simplifying synthetic audio processing

(75) Inventor: Chung-Hsien Lee, Hsinchu City (TW)

Correspondence Address: BACON & THOMAS, PLLC, 625 SLATERS LANE, FOURTH FLOOR, ALEXANDRIA, VA, 22314

(73) Assignee: Sunplus Technology Co., Ltd., Hsinchu (TW)

(21) Appl. No.: 10/730,074

(22) Filed: Dec. 9, 2003

(30) Foreign Application Priority Data
Jun. 2, 2003 (TW) 092114937

(51) Int. Cl. H04H 5/00; H04B 1/00

(52) U.S. Cl. 381/2; 381/15; 381/119

(57) ABSTRACT

A device for simplifying synthetic audio processing is disclosed, which establishes a wave-gain look-up table to store the relation of voltages for a wave to related gain values. During a synthetic audio processing, required multiplication operation in the prior art is replaced by addition of the gain values in the invention, thereby simplifying the synthetic audio processing.

### BACKGROUND OF THE INVENTION

1. Field of the Invention

The present invention relates to a processing device for synthetic audio and, more particularly, to a device for simplifying synthetic audio processing.

2. Description of Related Art

In current audio syntheses, a synthetic audio is generated by performing frequency modulation based on huge mathematical calculation by an audio synthesizer after communicating a lot of audio coefficients required by the synthesis with corresponding hardware, and subsequently output to a speaker for playing.

FIG. 1 is a block diagram of a typical audio synthesizer 80. The audio synthesizer 80 can be divided into three circuit-based sections: a modulation circuit 10, a controller 40 and an output circuit 50. The modulation circuit 10 can be implemented in many ways. For example, U.S. Pat. No. 4,813,326 granted to Hirano et al. for a “Method and apparatus for synthesizing music tones with high harmonic content”, as shown in FIG. 2 is provided to generate desired audio synthesis based on a predetermined modulation. The predetermined modulation can be frequency modulation (FM) or amplitude modulation (AM). An example is given in FM. For representing a modulating wave (assume that the timbre is piano) as an equation A(t)*SIN(ω_{c}t+I(t)*SIN ωₘt), it only requires inputting modulation parameters to the modulation circuit 10. Thus, the timbre's wave is produced. Further, the modulation parameters includes modulating wave phase angle data ωₘt, modulation wave data I(t), carrier phase angle data ω_{c}t, amplitude coefficient signal A(t) and tone color selection signal TC. Accordingly, the circuit 10 finally generates modulating wave shown in FIG. 3, which is the timbre of piano. However, the modulating wave is periodically repeated to present only a corresponding timbre. Different sounds of a timbre are generated only when the modulating wave is further input to the controller 40 to generate corresponding audio waves.

FIG. 4 is a schematic diagram of control parameters for an example ‘DO’ scale of FIG. 3. FIG. 5 shows an audio wave outputted by the controller 40 for the control parameters of FIG. 4. The control parameters include four kinds: attack, decay, sustain and release. The attack parameter amplifies the amplitude of the modulating wave. The decay parameter weakens the amplitude of the modulating wave. The sustain parameter nearly keeps on the amplitude of the modulating wave. The release parameter fades away the amplitude. When the controller 40 receives the modulating wave and applies the parameters to the modulating wave, as shown in FIG. 5, the audio wave of ‘DO’ scale for the timbre of piano is produced.

The audio wave requires further generating left channel synthetic audio L and right channel synthetic audio R through the output circuit 50. The output circuit 50 receives the audio wave and modulates it based on characteristic parameters, to output the audio L and R. The characteristic parameters include mute parameter Mute, volume control parameter VoCol, channel control parameter ChCol, left selection parameter L-Col and right selection parameter R-Col. The parameter Mute determines whether or not each audio wave is outputted. The parameter VoCol adjusts current volume of an audio wave. The parameter ChCol determines if the audio wave is output. The parameters L-Col and R-Col control an output ratio of left to right channels of the audio wave. Finally, the left audio L and another left audio L′ generated by output circuits 50 of another channels are added, and similarly the right audio R and another right audio R′ are added, thus generating and outputting the synthetic audio.

However, the cited audio synthesis processing needs a lot of multipliers 14 to do multiplication. For example, the cited Mute, VoCol, ChCol, L-Col and R-Col parameters of the output circuit 50 require doing multiplication to obtain corresponding functions, and thus it takes lots of time. In addition, the cited multipliers 14 are complicated and occupy a large circuit area. This causes that required area and power consumption for an audio synthesis circuit cannot be reduced any more. Therefore, it is desirable to provide an improved device to mitigate and/or obviate the aforementioned problems.

### SUMMARY OF THE INVENTION

The object of the present invention is to provide a device for simplifying synthetic audio processing, which establishes a wave-gain look-up table to directly synthesize audio using addition operation.

To achieve the object, the present invention provides a device for simplifying synthetic audio processing, which inputs an audio wave and performs modulation for outputting a synthetic audio. The device includes: a wave-gain look-up table, a conversion circuit, at least one adder and an inverse conversion circuit. The wave-gain look-up table stores voltages Si of the audio wave and related gain values Yi, where Yi=k×log Si and k is a constant. The conversion circuit converts the audio wave into related gain values. The adder adds the gain values and a tuning gain value to thus output a synthetic gain value. The inverse conversion circuit converts the synthetic gain value into the synthetic audio based on the wave-gain look-up table.

As cited, the inventive device uses the adder to replace multiplication with addition. Thus, the required size and power consumption for an audio synthesis circuit is effectively reduced.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical audio synthesizer;

FIG. 2 is a block diagram of a typical modulation circuit;

FIG. 3 is a schematic view of a modulating wave generated by the typical modulation circuit of FIG. 3;

FIG. 4 is a schematic diagram of an exemplary wave with respect to control parameters;

FIG. 5 shows an audio wave generated by a typical controller;

FIG. 6 is a block diagram of an audio synthesis circuit in accordance with the invention;

FIG. 7 is a schematic graph of a wave to gain relation in accordance with the invention; and

FIG. 8 is a view of a wave-gain look-up table in accordance with the invention.

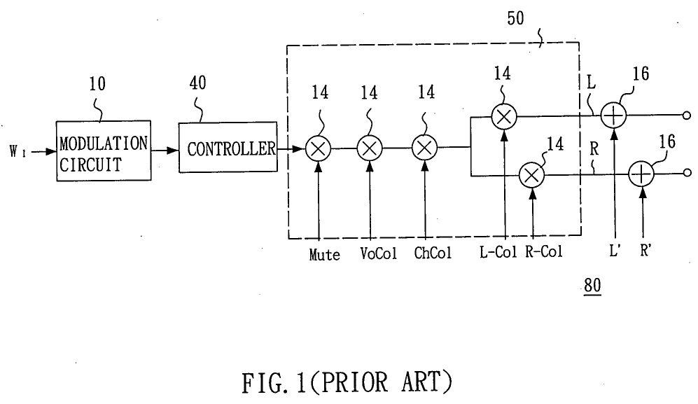

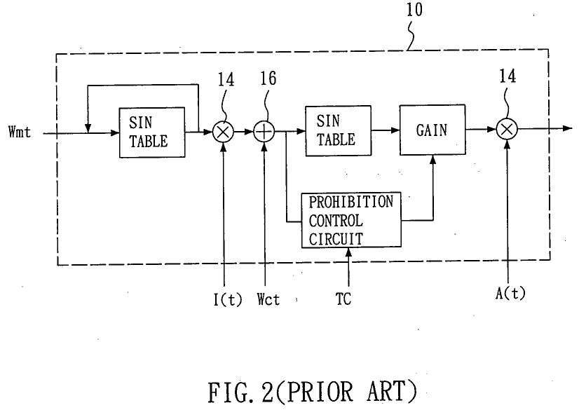

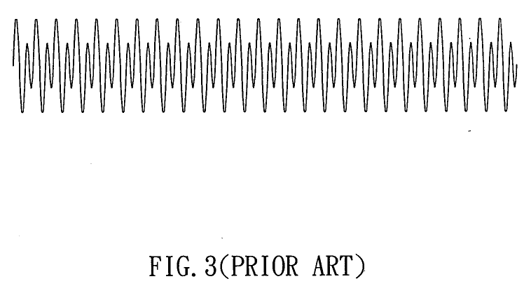

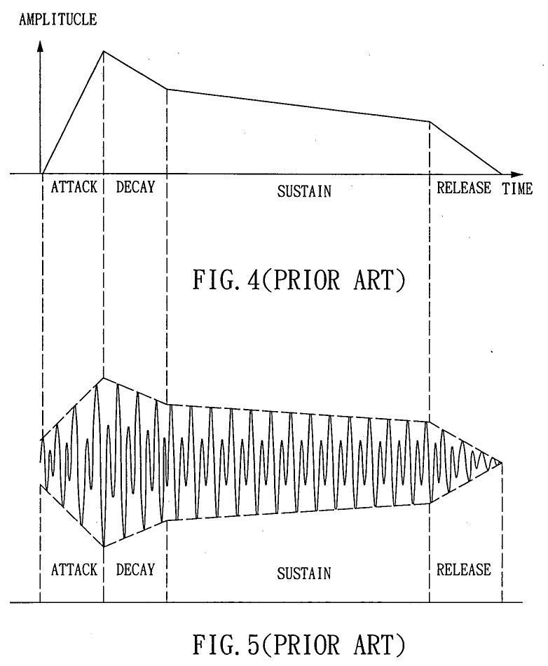

### DETAILED DESCRIPTION OF THE PREFERRED EMBODIMENT

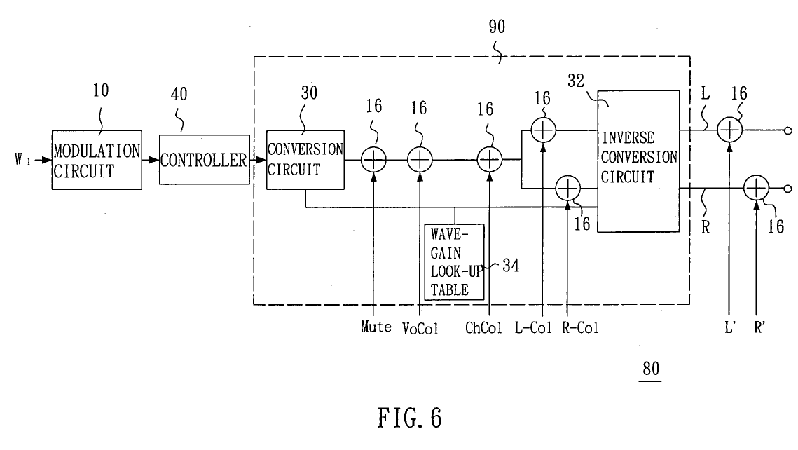

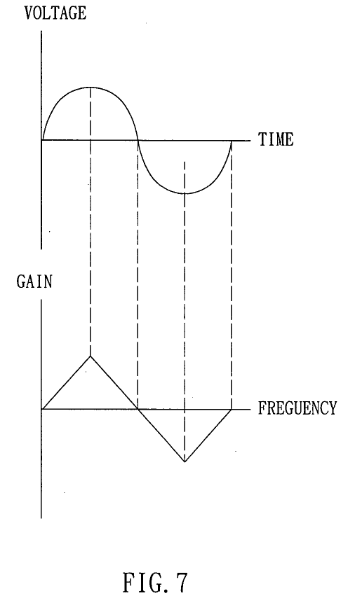

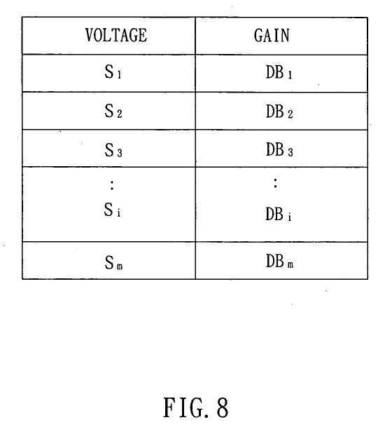

FIG. 6 is a block diagram of an audio synthesis circuit 80 in accordance with the invention, which includes a modulation circuit 10, a controller 40 and an output circuit 90. As shown, the output circuit 90 consists of a conversion circuit 30, an inverse conversion circuit 32, a wave-gain look-up table 34 and a plurality of adders 16. The look-up table 34 is pre-stored with gain values (dB) corresponding to waves, as shown in the schematic graph of the wave to gain relation of FIG. 7. For illustrative prupose, a sine wave SIN ω_{c}t is given in FIG. 7. For gain calculation, the sine wave is applied to logarithm operation to obtain related gain values. As shown in FIG. 7, these gain values form a straight line. For a positive cycle of the sine wave, the orresponding gain values form a straight line with a negative slope. On the contrary, for a negative cycle of the sine wave, the corresponding gain values form a straight line with a positive slope. With reference to an example of FIG. 8, the wave-gain look-up table 34 is stored with several voltages S₁, S₂, S₃ . . . Sₘ of a wave and related gain values DB₁, DB₂, DB₃ . . . DBₘ, where DBₓ=k×log Sₓ and k is a constant. In addition to that each related gain value is directly recorded, since related gain values form a straight line, it is able to indirectly find the related gain values by the recorded start point and slope of the line

The conversion circuit 30 converts an audio wave into related gain values based on the wave-gain look-up table 34, wherein the audio wave is generated after being modulated by the modulation circuit 10 and the controller 40. The modulation circuit 10 and the controller 40 are the same as in the prior art and thus a detailed description is deemed unnecessary. The inverse conversion circuit 32 converts input gain values into related voltages based on the table 34 to recover the wave.

During audio synthesis processing, it is required to perform operations equivalent to multiplication, such as adjustments of mute, volume control, channel control, left selection and right selection. The adders 16 are thus provided to do addition operation to achieve such adjustments. Taking the above A(t)*SIN(ω_{c}t+I(t)*SIN ωₘt) as an example, voltage (Sᵢ) of a current audio wave is multiplied by voltage (Sⱼ) of an adjustment signal to obtain voltage of a modulated wave Sₖ, which is expressed by:

Sₖ=Sᵢ×Sₖ (1)

Suppose that the cited Sᵢ and Sⱼ are gained before the multiplication, namely,

gain DBᵢ=20×log Sᵢ and gained DBⱼ=20×log Sⱼ, therefore,

$$\begin{matrix}gain {DB}_{k} = {DB}_{i} + {DB}_{j} \\ = 20 \times log {S}_{i} + 20 \times log {S}_{j} \\ = 20 \times log ( {S}_{i} \times {S}_{j} ) \\ = 20 \times log {S}_{k} .\end{matrix} \qquad ( 2 )$$

In the above equations, equation (1) is to perform multiplication (as employed in the conventional output circuit 50), and equation (2) is to perform addition, which is used by the inventive output circuit 90. That is, in this invention, an audio wave is converted into related audio gain values by the conversion circuit 30 based on the wave-gain look-up table 34, and gain values of a modulating signal and the audio gain values are subsequently added by the adders 16 to form synthetic gain values. The synthetic gain values are finally converted by the inverse conversion circuit 32 based on the look-up table 34 into an output wave to output. The output wave is equivalent to the audio wave multiplied by the adjustment signal. TIn this embodiment, the adders 16 are used to add the audio gain values and gain values of mute, volume control, channel control, left selection and right selection parameters, sequentially. By comparison, the calculation for equation (2) is much easier than for equation (1) and the addition circuit for the adders 16 is much simpler than the multiplication circuit for the multipliers 14.

Therefore, the invention can avoid complicated circuitry and waste of time caused by the multiplication operation. Instead, it can easily realize the audio synthesis by only relying upon the addition operation and the look-up table. As such, the invention can effectively reduce circuitry complexity and required time for the audio synthesis.

Although the present invention has been explained in relation to its preferred embodiment, it is to be understood that many other possible modifications and variations can be made without departing from the spirit and scope of the invention as hereinafter claimed.

What is claimed is:

1. A device for simplifying synthetic audio processing, which inputs an audio wave and performs modulation for outputting a synthetic audio, comprising:
a wave-gain look-up table, to store voltages Si of the audio wave and related gain values Yi, where Yi=k×log Si and k is a constant;
a conversion circuit, to convert the audio wave into related gain values;
at least one adder, to add the gain values and a modulating gain value to thus output a synthetic gain value; and
an inverse conversion circuit, to convert the synthetic gain value into the synthetic audio based on the wave-gain look-up table.

2. The device as claimed in claim 1, wherein the at least one adder is an adder that adds the audio gain values and a mute modulating gain value.

3. The device as claimed in claim 2, wherein the at least one adder further includes an adder that adds the audio gain values and a volume control modulating gain value.

4. The device as claimed in claim 3, wherein the at least one adder further includes an adder that adds the audio gain values and a channel control modulating gain value.

5. The device as claimed in claim 4, wherein the at least one adder further includes an adder that adds the audio gain values and a left selection modulating gain value.

6. The device as claimed in claim 5, wherein the at least one adder further includes an adder that adds the audio gain values and a right selection modulating gain value.
